(19) United States
(12) Patent Application Publication
(10) Pub. No.: US 2021/0266427 A1
(43) Pub. Date: Aug. 26, 2021

(54) CHAIR AND CHROMA KEY PHOTOGRAPHY BACKDROP ASSEMBLY THEREOF

(71) Applicant: Michael Kidakarn, Lawndale, CA (US)

(72) Inventor: Michael Kidakarn, Lawndale, CA (US)

(21) Appl. No.: 17/184,453

(22) Filed: Feb. 24, 2021

Related U.S. Application Data
(60) Provisional application No. 62/981,217, filed on Feb. 25, 2020.

(51) Int. Cl. H04N 5/222; H04N 5/272; H04N 5/247; H04N 9/75; H04N 13/282; A47C 7/62; A47C 7/68; A47C 7/72; A47C 7/74; A47C 7/00

(52) U.S. Cl. CPC H04N 5/2228; H04N 5/272; H04N 5/247; H04N 9/75; H04N 13/282; A47C 7/006; A47C 7/68; A47C 7/723; A47C 7/725; A47C 7/727; A47C 7/744; A47C 7/624

(57) ABSTRACT

A chair and chroma key photography backdrop assembly leverages the effect of chroma key photography with a collapsible chroma key panel integrated directly into a chair on which an actor sits during broadcast or video conference. The chair has at least one accessory retention arm that forms a cavity sized and dimensioned to retain broadcast equipment, including cameras and sound systems. The chair also has a shock absorber to absorb shock impulses from the actor who is sitting on the chair. Chroma key photography software in the cameras separate the solid color of the chroma key panel from the actor sitting in the chair, and replaces the solid color background of the chroma key panel with a virtual image or video and also separates the actor from the background, such that the actor appears to be in front of a virtual image or video. By deploying the chroma key panel from the chair, stowage, mobility, and efficiency are enhanced during video production.

### CROSS-REFERENCE TO RELATED APPLICATIONS

This non-provisional application claims priority under 35 U.S.C. § 119(a) on US Provisional Patent Application No(s). 62/981,217 filed on Feb. 25, 2020, the entire contents of which are hereby incorporated by reference.

### FIELD OF THE INVENTION

The present invention relates generally to a chair and chroma key photography backdrop assembly for broadcasting or video conference. More so, the chair is equipped with at least one accessory retention arm to retain multiple broadcasting devices and props. In addition, the chair and backdrop assembly provide a chair having a supportive shock absorber and at least one detachable accessory retention arm, a collapsible chroma key panel deployable directly behind the actor and to the sides of the chair, one or more cameras operable in front of the chair, and a sound system operatively connected to a microphone in the camera, both being stowable and operable from the accessory retention arms; whereby an actor sits in the chair, and is viewable in front of the collapsible chroma key panel such that the cameras layer the image of the actor and a video image together or separately based on color hues, or chroma range.

### BACKGROUND OF THE INVENTION

With the development of internet and social media, an individual online broadcasting or video conference is increasingly popularized in modern society. Not only celebrities or professional actors but also common people throughout all the industries are streaming online. It can be determined that broadcasting or video conference online will spread more widely in the future with the blooming of innovations in communication and the internet.

The broadcasting or video conference is suitable for everyone or any group, but the quality of broadcasting is quite different. Especially for the common people, the broadcasting or video conference effect can be greatly influenced by the condition of hardware or environment on the stream, including the selection of the live broadcast background or backdrop, the use of broadcasting or video conference apparatus, etc. Accordingly, with the thriving of streaming media, the related industry and market demand are increasing. For example, many people who want to achieve a good broadcasting or video conference effect and attract more viewers and subscribers, are contriving to design an attractive and fancy streaming or recording effect in some aspect, such as background, sound effect, visual effect, publicity effect, equipment, and the like, but most live broadcast's quality depends on by individual performance on the camera. Thus, the broadcasting or video conference effect for average people who has no experience on performance is poor.

Therefore, a demand to facilitate the live streaming for common people is proposed, especially to develop the technology on the hardware or accessory of live streaming in order to enhance the attraction and adaptability of the live show and recording. Some attention has been drawn to the development of a specified chair and backdrop for the live broadcast.

Throughout the prior art, engineers or designers have conceived some prototypes on the chair or the backdrop for the live broadcast. However, these chair design inventions were basically limited on the configuration of the chair itself, such as the comfortability, flexibility, and foldability, rather than on the improvement of live broadcast effects in entirety. The majority of actors or users during the broadcasting or video conference are still holding the broadcasting device in their hands or using an external bracket to support the device. It will cause inconvenience when the device needs to be moved or held for a long time. For example, the actor will be exhausted, and the images captured by the device are not stable, consequently resulting in an inferior efficiency and quality of the broadcasting.

On the other hand, some engineers have already manufactured the portable and detachable colorful backdrop panels, which can be attached to the backrest of the chair at the live streaming. Nevertheless, these designs specimens for backdrop panels have some flaws. For instance, the color or image patterns on the backdrop are not changeable; the pictorial elements on the backdrop are stationary; the under-way change of a backdrop panel will interrupt the live streaming show.

Thus, there is an urgent need for enhancing the live broadcast's quality, especially for common people.

### SUMMARY OF THE INVENTION

The invention provides a single chair equipped with one or more accessory retention arms and an assembly of the chair and chroma key photography backdrop during the broadcasting or video conference. One of the objectives of the present invention to solve the problems and flaws in the prior art, where the items or props are not accessible easily.

To solve the problem mentioned, the inventor has developed a chair furnished with a supportive shock absorber and at least one detachable accessory retention arm, one or more cameras operable in front of the chair, and a sound system operatively connected to a microphone in the camera, both being stowable and operable from the accessory retention arms; whereby the arms fixed under the bottom of the sitting portion of the chair.

Specifically, the invention can be presented in the following forms:

A chair for broadcast, the chair comprising:
a sitting portion and a backrest portion, the chair being sized and dimensioned to provide support for an object;
a shock absorber disposed adjacently to the sitting portion, or the backrest portion, or both, the shock absorber being operable to absorb and damp shock impulses from the object being supported on the sitting portion and the backrest portion; and

at least one accessory retention arm being fixed under the bottom of the sitting portion of the chair, the accessory retention arms comprising sidewalls that form a cavity, the cavity being sized and dimensioned to retain at least one of the following: a portable desk, a mobile phone, a monitor, a fan, a light source, a microphone, a sound system, one or more cameras, and a communication device. In another aspect of the embodiments, wherein an aroma diffuser being retained in the cavity of the retention arms, the aroma diffusor being operable to diffuse at least one aroma.

In another aspect of the embodiments, wherein a smoke diffuser being retained in the cavity of the retention arms, the smoke diffusor being operable to help diffuse smoke.

In another aspect of the embodiments, wherein a water spray being retained in the cavity of the retention arms, the water spray being operable to spray a mist.

In another aspect of the embodiments, wherein a vibration stimulation motor being integrated into the chair or retained in the cavity of the retention arms, the vibration stimulation motor being operable to vibrate the sitting portion and the backrest portion.

In another aspect of the embodiments, wherein the shock absorber is a spring coil or gas lift.

In another aspect of the embodiments, wherein the chair further comprises a wheel portion to enable mobility.

In another aspect of the embodiments, wherein the object is an actor.

In another aspect of the embodiments, wherein a decoration is assembled on the chair.

In another aspect of the embodiments, wherein the decoration is selected from a pair of angel wings or ears.

In another aspect of the embodiments, wherein at least a camera faces the object to capture the image.

In another aspect of the embodiments, wherein the accessory retention arms retain a left table and a right table.

In another aspect of the embodiments, wherein the left table and right table are connected through their edges fitting to each other.

In another aspect of the embodiments, wherein the left table and right table are connected by a fastener.

It is another objective of the present invention to solve the problems and flaws in the prior art, in which the users at a live broadcast show can't spontaneously and simultaneously control the postures of users sitting at the chairs, change the backdrop in different colors and images, and adjust visual and acoustical effect of the live streaming show, etc.

To solve the problem mentioned above, the inventor has alternatively conceived of a chair and backdrop assembly, a chair having a supportive shock absorber and at least one detachable accessory retention arm, a collapsible chroma key panel deployable directly behind the actor and to the sides of the chair, one or more cameras operable in front of the chair, and a sound system operatively connected to a microphone in the camera, both being stowable and operable from the accessory retention arms; whereby an actor sits in the chair, and is viewable in front of the collapsible chroma key panel such that the cameras layer the image of the actor and a video image together or separately based on color hues, or chroma range.

Specifically, the invention can be presented in the following forms:

In one embodiment, A chair and chroma key photography backdrop assembly, the assembly comprising:

a chair defined by a sitting portion and a backrest portion, the chair being sized and dimensioned to provide support for an object;

a shock absorber disposed adjacently to the sitting portion, or the backrest portion, or both, the shock absorber being operable to absorb and damp shock impulses from the object being supported on the sitting portion and the backrest portion;

at least one accessory retention arm detachably attached to the backrest portion of the chair, the accessory retention arms comprising sidewalls that form a cavity, the cavity being sized and dimensioned to retain at least one of the following: a portable desk, a mobile phone, a monitor, a fan a light source, a microphone, a sound system, one or more cameras, and a communication device; and a chroma key panel deployable from the backrest portion of the chair, the chroma key panel being defined by a solid color for capturing video images with one or more cameras;

whereby the cameras layer the image of the object in the chair and a video image together or separately based on the chroma range, whereby the captured image of the object is separated from the image of the chroma key panel, whereby a virtual image or video replaces the solid color background of the chroma key panel, such that the object appears to be in front of the virtual image or video.

In another aspect of the embodiments, wherein an aroma diffuser being retained in the cavity of the retention arms, the aroma diffusor being operable to diffuse at least one aroma.

In another aspect of the embodiments, wherein a smoke diffuser being retained in the cavity of the retention arms, the smoke diffusor being operable to help diffuse smoke.

In another aspect of the embodiments, wherein a water spray being retained in the cavity of the retention arms, the water spray being operable to spray a mist.

In another aspect of the embodiments, wherein a vibration stimulation motor being integrated into the chair or retained in the cavity of the retention arms, the vibration stimulation motor being operable to vibrate the sitting portion and the backrest portion.

In another aspect of the embodiments, wherein the shock absorber is a spring coil or gas lift.

In another aspect of the embodiments, wherein the chair further comprises a wheel portion to enable mobility.

In another aspect of the embodiments, wherein the solid color of the chroma key panel is green or blue.

In another aspect of the embodiments, wherein the chroma key panel comprises a green screen.

In another embodiment, wherein the chroma key panel slidably deploys and retracts into a housing.

In another embodiment, wherein the object is an actor.

In another embodiment, wherein four cameras angle to the object from a front view, a rear view, a left-side view, and a right-side view.

In another embodiment, wherein the capture videos by the four cameras are combined by chroma key photography software to create a three-dimensional playback or broadcast.

Based on the description of the invention above together, the chair and chrome key photography backdrop assembly can facilitate a live broadcast show for the users sitting in the chair to adjust the live show effect in different patterns, like adapting the user's postures and directions to the camera, changing the color hues of background, folding or unfolding the chroma key panel, controlling the sound and video of the live show, etc. Those actions can be executed conveniently in real-time.

The system and method of operation of the embodiments disclosed herein, however, together with additional objectives and advantages thereof, will be best understood from the following description of specific, exemplary embodiments when read in connection with the accompanying drawings.

### BRIEF DESCRIPTION OF THE DRAWINGS

The invention will now be described, by way of example, with reference to the accompanying drawings, in which:

FIG. 1 illustrates a perspective view of an exemplary chair and chroma key photography backdrop assembly, in accordance with an embodiment of the present invention.

FIG. 2 illustrates a frontal view of an actor sitting in front of a collapsible chroma key panel, in accordance with an embodiment of the present invention.

FIG. 3 illustrates a frontal view of the actor shown in FIG. 2, sitting in front of a collapsible chroma key panel with a video replacing the solid color of the collapsible chroma key panel, in accordance with an embodiment of the present invention.

FIG. 4 illustrates a side view of the actor, sitting in front of a collapsible chroma key panel with a rear camera behind the actor and the collapsible chroma key panel, in accordance with an embodiment of the present invention.

FIG. 5 illustrates a rear view of the back of the head of the actor shown in FIG. 2, sitting in front of a collapsible chroma key panel, representing the view from the camera in the back of the actor and the retention arm in front of the actor holding another chroma key backdrop. This provides a back of the head view of the actor. This camera angle is necessary to make a 3D video or 360° video of the actor, in accordance with an embodiment of the present invention.

FIG. 6 illustrates a perspective view of multiple accessory retention arms carrying various accessories, such as a fan, a water spray, a table, and a mobile communication device holder, in accordance with an embodiment of the present invention.

FIG. 7 illustrates a perspective view of an individual arm holding a mobile phone and a mobile communication device holder in a single chair, in accordance with an embodiment of the present invention.

FIG. 8 illustrates a perspective view of an individual arm holding a mobile phone in front of an actor and a mobile communication device holder in a single chair, in accordance with an embodiment of the present invention.

FIG. 9 illustrates a perspective view of an individual arm holding a display monitor and a mobile communication device holder in a single chair, in accordance with an embodiment of the present invention.

FIG. 10 illustrates a perspective view of an arm holding the left table and an arm holding the right table in a single chair, in accordance with an embodiment of the present invention.

FIG. 11 illustrates a perspective view of a jointed position of an arm holding the left table and an arm holding the right table in a single chair, in accordance with an embodiment of the present invention.

FIG. 12 illustrates a perspective view of an individual arm holding a mobile phone in front of the actor and two arms holding the jointed table in a single chair, in accordance with an embodiment of the present invention.

FIG. 13 illustrates a perspective view of an individual arm holding mobile phone and a backdrop behind the actor in an assembly, in accordance with an embodiment of the present invention.

FIG. 14 illustrates a perspective view of an individual arm holding a mobile phone and backdrop and multiple viewing cameras in an assembly, in accordance with an embodiment of the present invention.

FIG. 15 illustrates a perspective view of a pair of angel wings mounted on the chair, in accordance with an embodiment of the present invention.

FIG. 16 illustrates a perspective view of a pair of decorative props mounted on the chair, in accordance with an embodiment of the present invention.

Like reference numerals refer to like parts throughout the various views of the drawings.

### DETAILED DESCRIPTION OF THE INVENTION

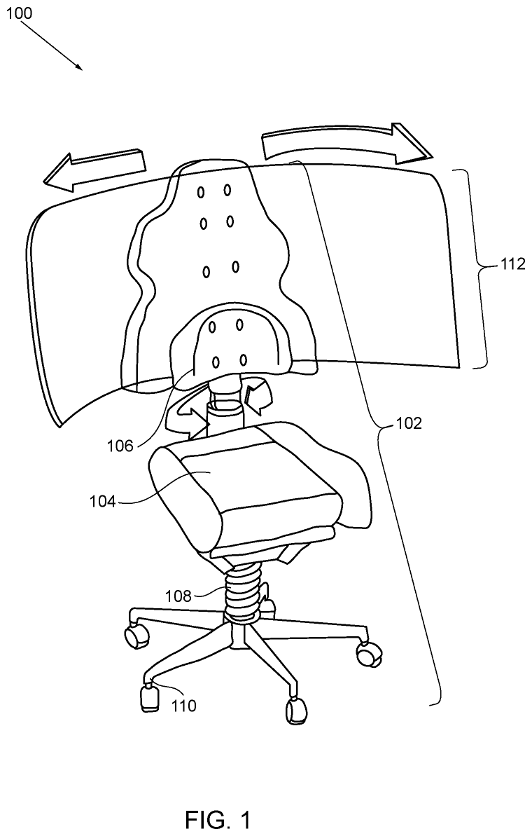

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one aspect of the present invention, a chair and chroma key photography backdrop assembly comprises:
a chair defined by a sitting portion and a backrest portion, the chair being sized and dimensioned to provide support for an object;
a shock absorber disposed adjacently to the sitting portion, or the backrest portion, or both, the shock absorber being operable to absorb and damp shock impulses from the object being supported on the sitting portion and the backrest portion; and
at least one accessory retention arm being fixed under the bottom of the sitting portion of the chair, the accessory retention arms and comprising sidewalls that form a cavity, the cavity being sized and dimensioned to retain at least one of the following: a portable desk, a mobile phone, a monitor, a fan, a light source, a microphone, a sound system, one or more cameras, and a communication device;
a chroma key panel deployable from the backrest portion of the chair, the chroma key panel being defined by a solid color for capturing video images with the one or more cameras;
whereby the cameras layer the image of the object in the chair and a video image together or separately based on the chroma range,
whereby the captured image of the object is separated from the image of the chroma key panel,
whereby a virtual image or video replaces the solid color background of the chroma key panel, such that the object appears to be in front of the virtual image or video.

In a second aspect, an aroma diffuser being retained in the cavity of the retention arms, the aroma diffusor being operable to diffuse at least one aroma.

In another aspect, a smoke diffuser being retained in the cavity of the retention arms, the smoke diffusor being operable to help diffuse smoke.

In another aspect, a water spray being retained in the cavity of the retention arms, the water spray being operable to spray a mist.

In another aspect of the embodiments, wherein a vibration stimulation motor being integrated into the chair or retained in the cavity of the retention arms, the vibration stimulation motor being operable to vibrate the sitting portion and the backrest portion.

In another aspect, the shock absorber is a spring coil or gas lift.

In another aspect, the chair also includes a wheel portion to enable mobility.

In another aspect, the solid color of the chroma key panel is green or blue.

In another aspect, the chroma key panel comprises a green screen.

In another aspect, the chroma key panel slidably deploys and retracts into a housing.

In another aspect, the object is an actor.

In another aspect, four cameras angle to the object from a front view, a rear view, a left-side view, and a right-side view.

In another aspect, the capture videos by the four cameras are combined by chroma key photography software to create a three-dimensional playback or broadcast.

The above embodiment creates the adjustability and interchangeability of different backdrops and the recordings images.

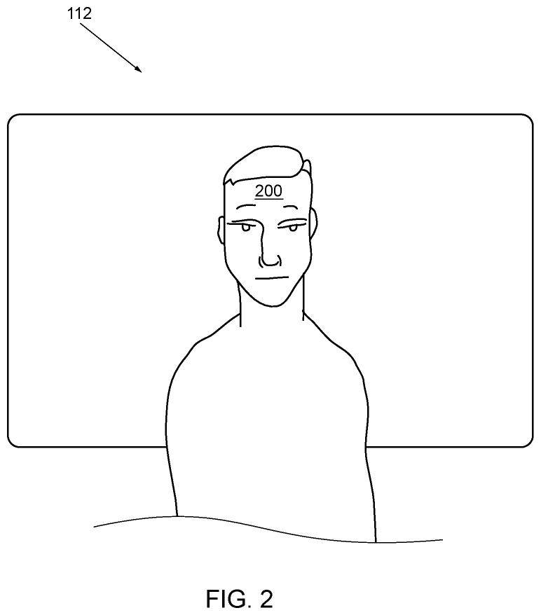

In one embodiment of the present invention presented in FIGS. 1-6, a chair and chroma key photography backdrop assembly 100 leverages the effect of chroma key photography with a collapsible chroma key panel 112 that is integrated and deployable directly behind an actor 200 and to the sides of the chair 102 on which an actor 200 sits during broadcast. The chroma key panel 112 deploys directly behind, and to the left and right side of the actor 200 sitting on the chair 102. The chair 102 has at least one accessory retention arm comprising sidewalls that form a cavity sized and dimensioned to retain broadcast equipment, including cameras 400, sound systems, lights, and fans. The chair 102 also has a shock absorber 108 to absorb shock impulses from the actor 200 who is sitting on the chair 102. Chroma key photography software in the cameras 400 separate the solid color of the chroma key panel 112 from the actor 200 sitting in the chair 102, and replaces the solid color background of the chroma key panel 112 with a virtual image or video, such that the actor 200 appears to be in front of a virtual image or video. By deploying the chroma key panel 112 from the chair 102, stowage, mobility, and efficiency are enhanced during video production.

One objective of the present invention is to integrate a green screen into a chair 102, and enable the chair 102 to stow video production supplies, such as a portable desk, a fan a light source, a microphone, a sound system, one or more cameras 400, and a communication device.

Another objective is to create a clean and tidy environment for broadcasting or video conference in which all supplies are condensed into a simple chair 102.

Yet another objective is to create the privacy effect of a room from a chair 102 and integrated green screen.

An exemplary objective is to hide the location of the actor 200, as the cameras 400 and chroma key panel 112 allow broadcasting or video conference from any location.

Additional objectives are to provide chroma key photography software that separates the actor 200 in the chair 102 from the chroma key panel 112.

Additional objectives are to generate images and videos of advertisements on the chroma key panel 112 behind the actor 200.

Additional objectives are to provide an easy to use and manufacture chair 102 and chroma key photography backdrop assembly 100.

Those skilled in the art will recognize that it is common for performers and entertainers to broadcast (streaming) and record videos from their home. With many competitive performers and streamers, the performer must keep their viewers entertained and engaged. Watching a performer with the same background and environment for many sessions becomes tedious and tiresome, and boring for the viewer. Also broadcast performers (streamers) are able to earn money based on the volume quantity of their viewer base and also from advertisers that pay to place their logo, product and service to the viewer base. The present invention creates a compact, cost-effective broadcasting system that combines a chair 102 with a chroma key panel 112 and other broadcasting or video conference equipment.

As referenced in FIG. 1, the assembly 100 provides a unique chair 102 that is sized and dimensioned to receive an actor 200 during filming of a video during broadcast. The chair 102 has a sitting portion 104, such as a padded seat that an actor 200 can sit on during broadcast. The chair 102 also has a backrest portion 106 that the actor 200 can lean back on for lumbar and lower back support. The chair 102 provides a foundation for the actor to speak, act, and present information from. The chair 102 may also include a wheel portion 110 that enables mobility. This can include wheels and rollers on a foundation base.

In some embodiments, the chair 102 has a supportive shock absorber 108. The shock absorber 108 helps support the weight of the actor 200 and any objects that is stored in the chair 102. The shock absorber 108 rests adjacently to the sitting portion 104, providing vertical support. However, in alternative embodiments, the supportive shock absorber 108 rests adjacent to the backrest portion 106. In this manner, the load or shock waves generated by the weight of the actor 200 during broadcasting or video conference is absorbed and dampened by either, or the sitting portion 104 and the backrest portion 106. In one non-limiting embodiment, the supportive shock absorber 108 includes a coil spring that has an adjustable coil strength. Optionally, the shock absorber 108 can apply a gas lift mechanism to support the sitting portion.

In yet other embodiments, the chair 102 includes at least one accessory retention arm that are detachably attached to the backrest portion 106 of the chair 102. The accessory retention arms provide support for the arms of the actor 200, while also serving as a unique storage site for broadcasting equipment. In some embodiments, the accessory retention arms are elongated, and include sidewalls that form a cavity that is sized and dimensioned to retain various types of broadcast equipment. This equipment may include, without limitation, a portable desk, a mobile phone, a monitor, a fan a light source, a microphone, a sound system, one or more cameras 400, and a communication device. The cameras 400 can be deployed in front of the chair 102 for capturing images and video of the actor 200 in front of a chroma key panel 112, as described below.

In one exemplary assemblage of broadcasting equipment: a portable desk provides a flat surface or to placement of items. A fan provides wind effects for dynamic video broadcast and video capture. A light source, such as a lamp, provides light effects for dynamic video broadcast and video capture. A microphone picks up sound from the actor 200 and can be held at a desired position by the accessory retention arms or mounts. One or more cameras 400 can also be retained at a desired position by the accessory retention arms or mounts. A smart device, such as a smart phone or tablet provides easy access to video controls and video displays. All of these components, and more can be stowed in accessory retention arms.

In yet other embodiments, the assemblage of broadcasting equipment provides a sensation of realism to the actor of the scene, setting, interactive game or virtual reality environment. For example, the accessory retention arms can retain an aroma diffuser, which is operable to diffuse at least one aroma. The accessory retention arms can also hold a smoke diffuser to help diffuse smoke from broadcasting special effects, or simply from a cigarette/cigar. To help cool down the actor, the accessory retention arms 1 10a-b can retain a water spray for spraying a mist on the actor. This can help cool the actor or provide hydration to the actor. In other embodiments, a vibration stimulation motor is integrated into the chair or retained in the cavity of the retention arms. The vibration stimulation motor is operable to vibrate the sitting portion and the backrest portion. This creates a massaging effect for the actor.

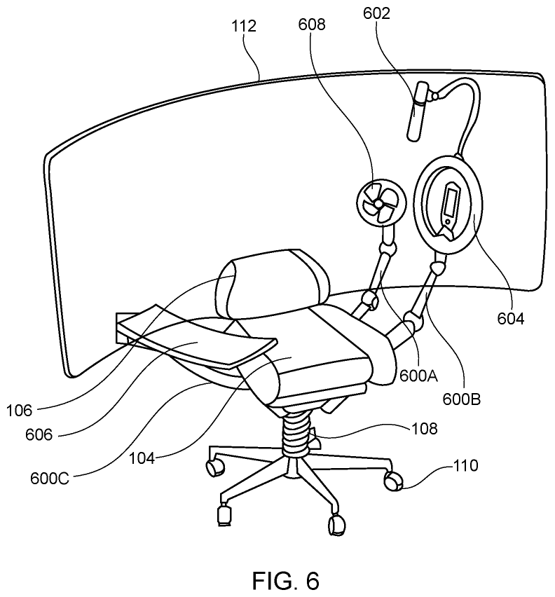

In yet another example of the utilization of the accessory retention arms, FIG. 6 illustrates a perspective view of multiple accessory retention arms 600a, 600b, 600c carrying various accessories, such as a fan 608 for cooling the actor during broadcast; a water spray 602 to enable the actor drinking water during broadcast; a table 606 for holding laptops, keyboards, papers and eating off; a ring light 604 for casting an even light onto the objector (actor) and reducing shadows in the face, while illuminating the eyes of actor; and a mobile communication device holder for holding a smart phone, tablet, and the like. Optionally, the mobile communication device holder is mounted in the inner of the ring light 604. The accessory retention arms 600a, 600b, 600c are adjustable around the actor for easy access to the accessories.

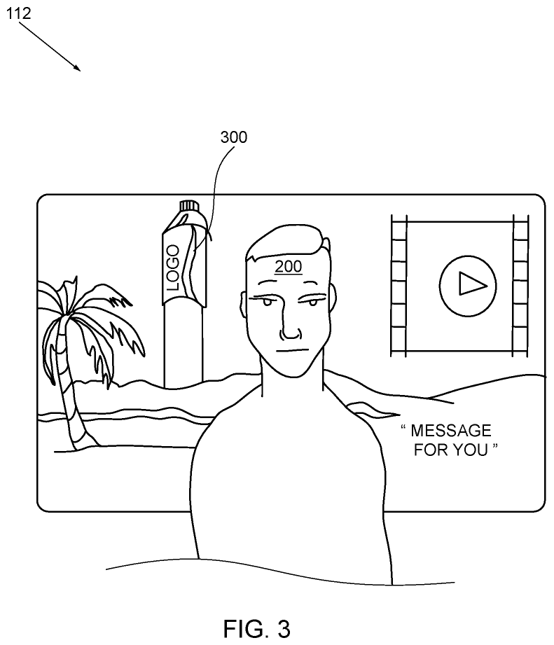

Turning now to FIG. 3, the assembly 100 provides a collapsible chroma key panel 112 that is integrated into the chair 102. This unique combination creates a single chair 102 stores and broadcasts with internal broadcast equipment, and a chroma key panel 112, creating a compacted broadcasting or video conference system. The chroma key panel 112 may include by a resilient flat surface defined by a solid color for capturing video images with the one or more cameras 400. In one embodiment, the chroma key panel 112 is a surface that does not reflect much light or create shadows, such as a muslin fabric or synthetic green screen known in the art.

The chroma key panel 112 is deployable directly behind the actor and to the sides of the chair 102, possible stowing and deploying from the accessory retention arms. In some embodiments, the chroma key panel 112 slidably deploys and retracts into a housing. In other embodiments, the chroma key panel 112 may fold or telescopically slide between deployed and retracted positions. In other alternative embodiments, the chroma key panel 112 stows and deploys directly from the accessory retention arms. The chroma key panel 112 can also swivel from behind the chair 102 to a retracted position in the accessory retention arms. In any case, the resilient configuration of the chroma key panel 112 allows for various means to deploy directly from the housing, the backrest portion 106, or the sitting portion 104.

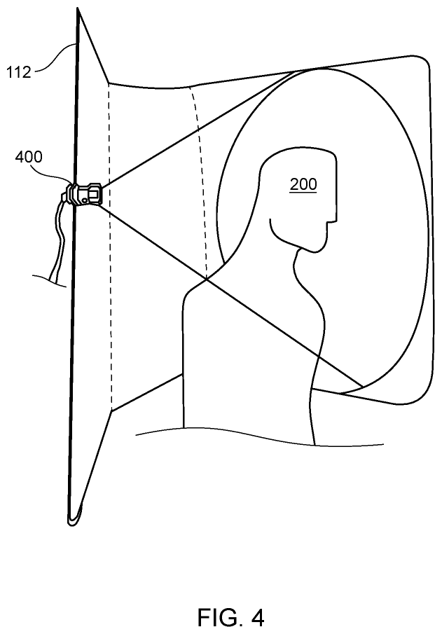

As FIG. 4 shows, the chroma key panel 112 may extend from directly behind the chair 102 (and the actor 200 in the chair 102), or to the left and right sides of the chair 102. This creates a panoramic view around the actor 200. In other embodiments, the actor 200 can be facing away from the cameras 400, looking directly at the chroma key panel 112.

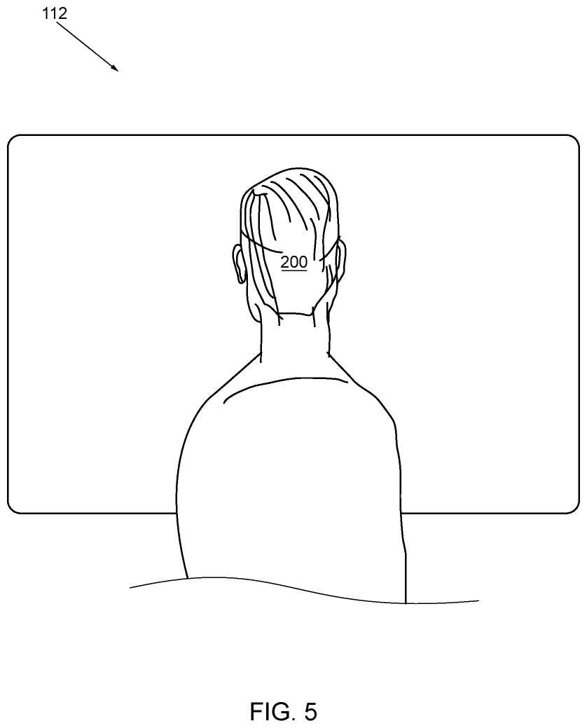

For example, FIG. 5 illustrates a rear view of the back of the head of the actor sitting in front of a collapsible chroma key panel, representing the view from the camera in back of the actor and the retention arm in front of the actor holding another chroma key backdrop. This provides a back of the head view of the actor. This camera angle is necessary to make a 3D video or 360° video of the actor. In any case, the chroma key panel 112 is in the line of sight behind the actor 200 while sitting on the chair 102.

It is known in the art that by using a camera directly in front and facing the actor 200, the chair 102 with chroma key panel 112 backdrop can separate the actor 200 from the background; thereby generating a virtual image or video in place of the solid color of the chroma key panel 112. Further, a sound system operatively connects to a microphone in the camera. The cameras 400 and the sound system are both stowable and deployable from the cavity of the accessory retention arms.

In one exemplary use, a wheeled chair 102 with a green screen background is angled to surround the actor 200. With the cameras on the left and right and back and front of the actor 200, each camera can capture the actor 200 and separate the actor 200 from the background. This is achieved by each camera individually and capturing the actor 200 from four different directions, including a front view, a rear view, a left-side view, and a right-side view. For example, Camera 1 is front facing, separating the actor 200 from the chroma key panel 112. Camera 2 is left facing, separating the actor 200 from the chroma key panel 112. Camera 3 is right facing, separating the actor 200 from the chroma key panel 112. Camera 4 is rear facing, separating the actor 200 from the chroma key panel 112.

The four camera angles are combined by chroma key photography software to create a three-dimensional playback or broadcast of the accessory retention arms. Playback of the video in a specific format and layout can create a three-dimensional, holographic, or virtual reality version of the actor 200. Furthermore, the cameras may be attached directly to the chroma key panel 112 or stowed inside the accessory retention arms.

In operation of the assembly 100, one or more cameras 400 are operable in front of the chair 102 for capturing videos and images of the actor 200. The cameras 400 are positional in front of the chair 102 and the chroma key panel 112 that extends behind. Thus, when an actor 200 sits the chair 102, the actor 200 is viewable in front of the collapsible chroma key panel 112, such that the cameras layer the image of the actor 200 and a video image together or separately based on color hues, or the chroma range. The use of a background layer displays dynamically changing graphics, videos, and advertisements. This creates more interesting and entertaining content. FIG. 3 illustrates a frontal view of the actor sitting in front of a collapsible chroma key panel with a video replacing the solid color of the collapsible chroma key panel 112.

In the below descriptions, the present invention also presented some alternative embodiments specified with a single chair for broadcasting, without an assembled part of the chroma key panel. It is for sure that the optional combination of the chair with a chroma key panel (for example, chroma key panel 112 mentioned above) in those alternative embodiments can be achieved and is included in the protection of the present invention.

In one aspect of the present invention, a chair for broadcast, the chair comprising:
a sitting portion and a backrest portion, the chair being sized and dimensioned to provide support for an object;
a shock absorber disposed adjacently to the sitting portion, or the backrest portion, or both, the shock absorber being operable to absorb and damp shock impulses from the object being supported on the sitting portion and the backrest portion; and
at least one accessory retention arm being fixed under the bottom of the sitting portion of the chair, the accessory retention arms comprising sidewalls that form a cavity, the cavity being sized and dimensioned to retain at least one of the following: a portable desk, a mobile phone, a monitor, a fan, a light source, a microphone, a sound system, one or more cameras, and a communication device.

In a second aspect, an aroma diffuser being retained in the cavity of the retention arms, the aroma diffusor being operable to diffuse at least one aroma.

In another aspect, a smoke diffuser being retained in the cavity of the retention arms, the smoke diffusor being operable to help diffuse smoke.

In another aspect, a water spray being retained in the cavity of the retention arms, the water spray being operable to spray a mist.

In another aspect, a vibration stimulation motor being integrated into the chair or retained in the cavity of the retention arms, the vibration stimulation motor being operable to vibrate the sitting portion and the backrest portion.

In another aspect, the shock absorber is a spring coil or gas lift.

In another aspect, the chair further comprises a wheel portion to enable mobility.

In another aspect, the object is an actor.

In another aspect, the chair, a decoration is assembled on the chair.

In another aspect, the decoration is selected from a pair of angel wings or ears.

In another aspect, at least a camera faces the object to capture the image.

In another aspect, the accessory retention arms retain a left table and a right table.

In another aspect, the left table and right table are connected through their edges fitting to each other.

In another aspect, the left table and right table are connected by a fastener.

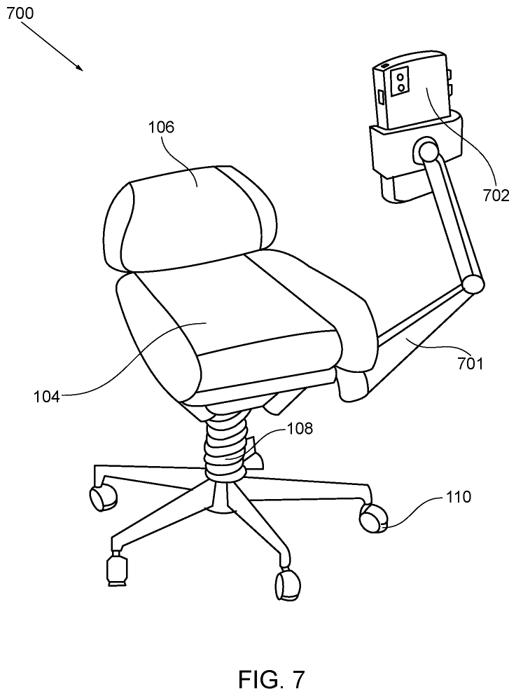

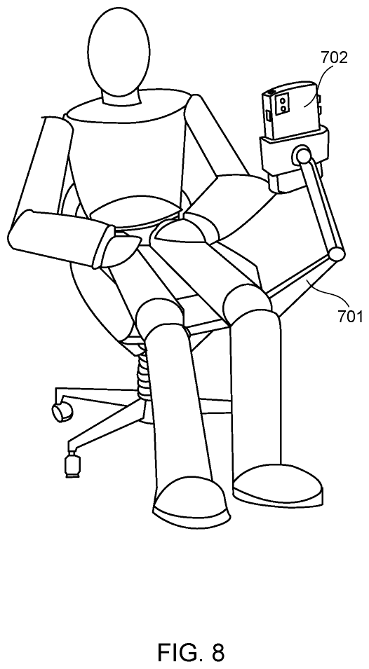

In one embodiment of the present invention presented in FIG. 7, it provides a single chair 700 for broadcasting. The chair 700 has a sitting portion 104, such as a padded seat that an actor (as presented in FIG. 8) can sit on during broadcast. The chair 700 also has a backrest portion 106 that the actor can lean back on for lumbar and lower back support. The chair 700 provides a foundation for the actor to speak, act, and present information from. The chair 700 may also include a wheel portion 110 that enables mobility. This can include wheels and rollers on a foundation base. Further, the chair 700 contains at least an arm 701. One end of the arm 701 is mounted under sitting portion 104 and other end of the arm 701 comprises sidewalls that form a cavity, the cavity being sized and dimensioned to retain at least one item 702 of the following: a portable desk, fan, light source, microphone, mobile phone, monitor, sound system, camera, a communication device, or any other applicable props during broadcasting. In the embodiment, preferably the arm 701 holds a smart phone. Under this situation, the actor (presented in FIG. 8) can simply broadcast to the phone via a broadcast mobile application or record a video via the phone camera. The arm 701 can be an accessory retention arm; preferably it can be flexible or bendable; preferably it consists of multiple joints. Such this configuration for the chair 102 can free the actor's hands and make the actor more comfortable and flexible instead of being tired and nervous. In addition, the fixation of arm 701 under the sitting portion 104 achieve more stabilization of the phone or camera held by the arm 701 to prevent the broadcasting or video conference image from being shaked and vibrated.

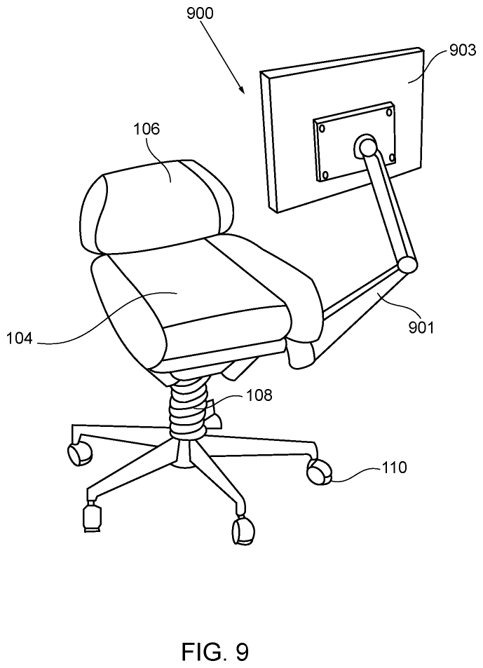

In one embodiment of the present invention presented in FIG. 9, it provides a single chair 900 assembled with at least an arm 901 during filming of a video during broadcast. Likewise, the chair 900 has a sitting portion 104, such as a padded seat that an actor (as presented in FIG. 8) can sit on during broadcast. The chair 900 also has a backrest portion 106 that the actor can lean back on for lumbar and lower back support. In addition, the chair 900 may also include a wheel portion 110 that enables mobility. This can include wheels and rollers on a foundation base. Like the arm in last embodiment in FIG. 7, one end of the arm 701 is mounted under sitting portion 104. But other end of the arm 901 comprises sidewalls that form a frame or bracket, which is sized and dimensioned to retain a display monitor or tablet. Similarly, the structure of the chair 900 can free the actor hands and enhance the facilitation and stabilization of the broadcasting.

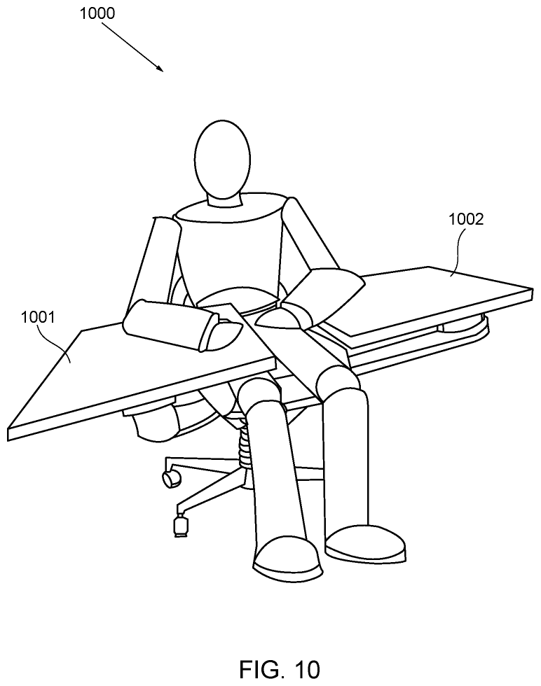

In one embodiment of the present invention presented in FIG. 10, it provides a single chair 1000 assembled with foldable left table 1001 and right table 1002 during filming of a video. Preferably, the height of left table 1001 and right table 1002 are the same. Optionally, fixed to the bottom of each of the tables is one end of an arm, and other end of the arm fixed under the sitting portion of the chair. Each of arms has at least one moveable joint to achieve the mobility and flexibility. Accordingly, each table can move horizontally at a fixed height, independently. For instance, the left table 1001 and right table 1002 can move far away to each other.

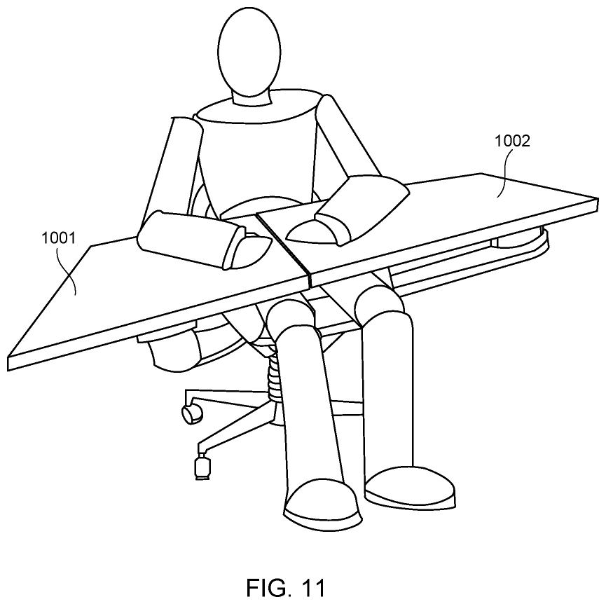

In another aspect of the present invention presented in FIG. 11, the left table 1001 and right table 1002 can be connected detachably. Preferably, the connection can be realized through their edges fitting to each other or by a fastener. Optionally, the fastener comprises a bolt, nut or screw. Preferably, the fastener is anchored under the bottom of the two tables.

Thus, the embodiment in FIGS. 10-11 presents a chair assembled with two tables, where the two table are connected or detached flexibly. The tables create space that can be used to place props during broadcasting. For example, laptops, keyboards, food, drinks or any items that needs to be presented or utilized during the broadcasting or video conference can be placed on the tables so that the actor can access the items on the table in handy. In addition, the mobility and detachability of the tables facilitate the actor to sit down or stand up in different postures.

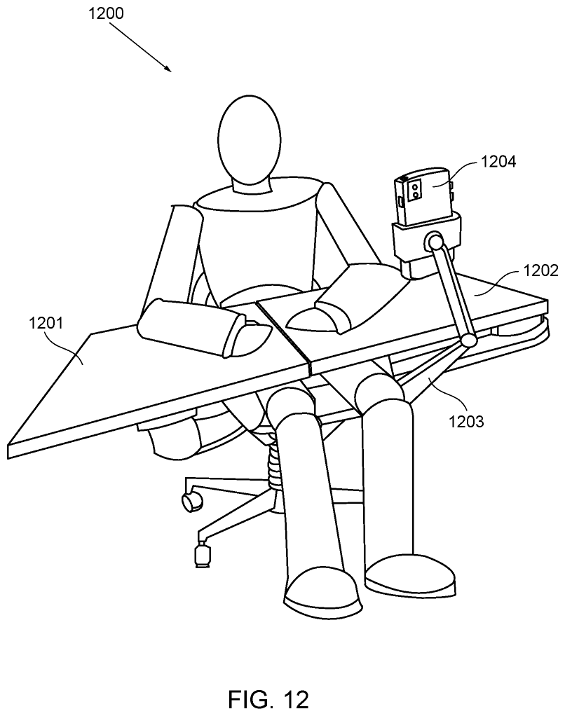

As another changeable embodiment presented in FIG. 12, an additional arm 1203 fixed under the bottom of the sitting portion of the chair 1200 extends over the table's edge to hold a device, preferably a mobile phone 1204 in front of an actor during the broadcasting. The arm 1203 can be an accessory retention arm; preferably it can be flexible or bendable; preferably it consists of multiply joints. Such this configuration for the arm 1203 adjusts the position of the mobile phone 1204 or its holding device to set the camera of the align to the presented object or the actor interchangeably during the broadcasting. The actor's hands are free rather than holding the device. Also, the table can create space to place the keyboards, laptops, food and drinks. In addition, the actor can rest his/her hands on the connected table. The comfortability and adjustability of the actor can boost the quality and efficiency of the broadcasting.

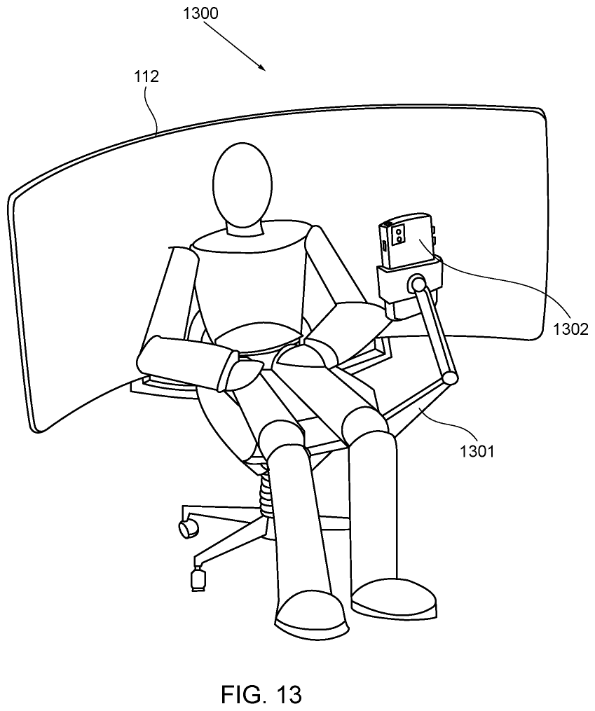

In one embodiment of the present invention presented in FIG. 13, a chair and chroma key photography backdrop assembly 1300 leverages the effect of chroma key photography with a collapsible chroma key panel 12 that is integrated and deployable directly from a chair on which an actor sits during broadcasting. The chroma key panel 112 deploys directly behind the actor and to the sides of the chair, specifically to the left and right side of the actor sitting on the chair. The chair has at least an accessory retention arm 1301 comprising sidewalls that form a cavity sized and dimensioned to retain broadcast equipment 1302, optionally choosing from mobile phones, cameras, sound systems, lights, and fans, etc. The chair also has a shock absorber to absorb shock impulses from the actor who is sitting on the chair. In this embodiment, the broadcast equipment 1302 is a mobile phone with a camera. A chroma key photography software in the mobile phone separates the solid color of the chroma key panel 112 from the actor sitting in the chair, and replaces the solid color background of the chroma key panel 112 with a virtual image or video, such that the actor appears to be in front of a virtual image or video. By deploying the chroma key panel 112 from the chair, stowage, mobility, and efficiency are enhanced during video production.

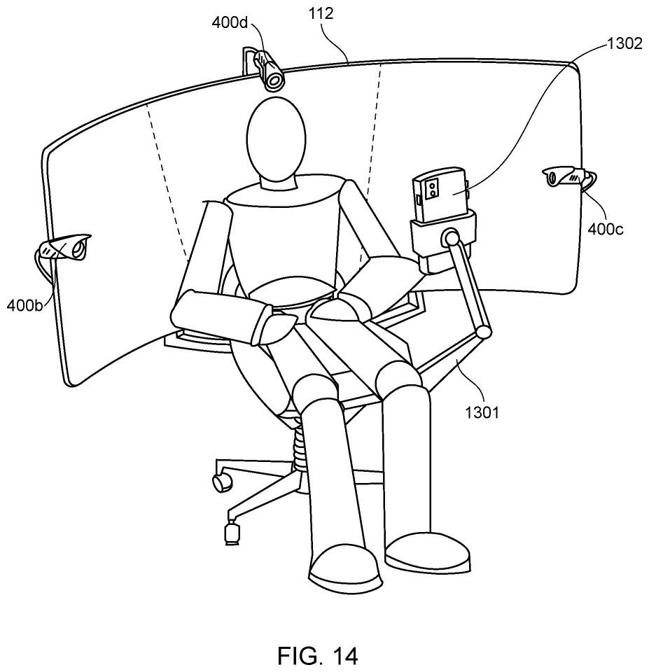

In one preferable embodiment of the present invention presented in FIG. 14, multiple cameras are angled to surround the actor. With the cameras on the left and right and back and front of the actor, each camera can capture or record the actor and separate the actor from the background via the chroma key photography software respectively. This is achieved by each camera individually and capturing the actor from four different directions, including a front view, a rear view, a left-side view, and a right-side view. For example, Camera 1 is front facing, separating the actor 200 from the chroma key panel 112. Said Camera 1 can be a mobile phone 1302 with a camera. Camera 400b is left facing, separating the actor from the chroma key panel 112. Camera 400c is right facing, separating the actor from the chroma key panel 112. Camera 400d is rear facing, separating the actor from the chroma key panel 112. In this embodiment, an accessory retention arm 1301 fixed under the bottom of the sitting portion of the chair can hold the front camera angled to the actor.

The recordings of four cameras are combined by chroma key photography software to create a three-dimensional playback or broadcast of the actor. The device can be the mobile phone 1302 with a camera. Preferably, the mobile phone is held by the accessory retention arm. Playback of the video in a specific format and layout can create a three-dimensional, holographic, or virtual reality version of the actor. Furthermore, the cameras may be attached directly to the chroma key panel 112 or held inside the accessory retention arm 1301.

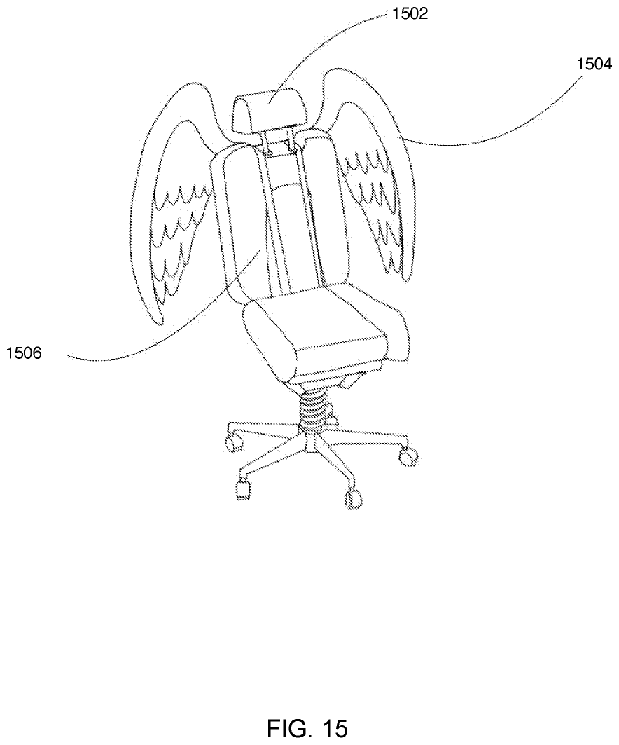

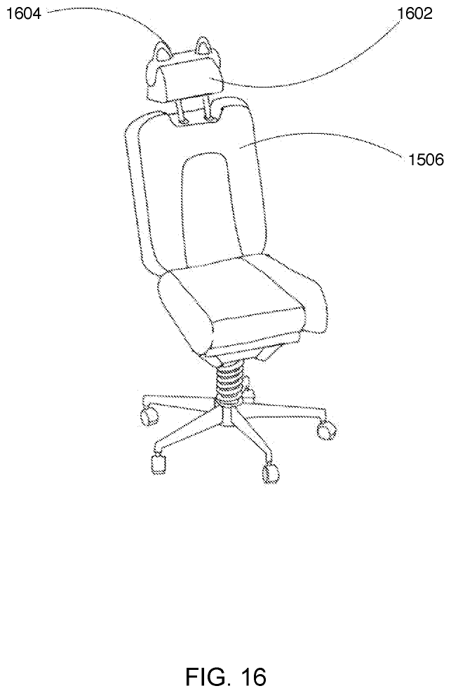

The present invention also provides some different assemblies with the chair to make the broadcasting attractive, as shown in FIG. 15 and FIG. 16. In another embodiment as shown in FIG. 15, the chair optionally equipped with accessory retention arms has a larger and higher backrest portion 1506. A pair of angel wings 1504 is attached on the back of the backrest portion 1506, so that the actor sitting on the chair looks like wearing an angle to attract the viewers on a broadcasting. The pair of angel wings 1504 can be attached detachably via sticking or tying. Optionally, the chair contains a headrest 1502. The headrest 1502 is mounted on the backrest portion 1504, and the height of the headrest 1502 is adjustable.

Likewise, in a changeable embodiment as shown in FIG. 16, the chair has a backrest portion 1506, headrest 1602 and decoration 1604. Preferably, the decoration 1604 is attached on the headrest 1602 detachably. Preferably, the decoration 1604 is shaped to a pair of ears of some animals including a cat, rabbit, dog, etc. or character decoration including hats and head dresses. The headrest 1602 is mounted on the backrest portion 1506, and the height of the headrest 1602 is adjustable. Those varied decorations assembled with the chair enhance the appealing during a broadcasting.

The invention includes but not limits all the embodiments above. Especially, the parts of the chair and the assembly are interchangeable, additional or omittable between different embodiments contingent.

Alternatively, in all the embodiments of the present invention presented above, the said chair can be the same chair as shown in FIG. 1.

Alternatively, in all the relevant embodiments of the present invention presented above, the said collapsible chroma key panel can be the same chroma key panel as shown in FIG. 1.

Alternatively, all the arms mentioned above in the all the embodiments can be accessory retention arm; preferably it can be flexible or bendable; preferably it consists of multiple joints. Such this configuration for the chair can free the actor's hands and make the actor more comfortable and flexible instead of being tired and nervous. In addition, the fixation of the arm under the sitting portion 104 achieves more stabilization of the phone or camera held by the arm to prevent the broadcasting or video conference image from being shaked and vibrated.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A chair for broadcasting or video conference, the chair comprising:
a sitting portion and a backrest portion, the chair being sized and dimensioned to provide support for an object;
a shock absorber disposed adjacently to the sitting portion, or the backrest portion, or both, the shock absorber being operable to absorb and damp shock impulses from the object being supported on the sitting portion and the backrest portion; and
at least one accessory retention arms being fixed under the bottom of the sitting portion of the chair, the accessory retention arms comprising sidewalls that form a cavity, the cavity being sized and dimensioned to retain at least one of the following: a portable desk, a mobile phone, a monitor, a fan, a light source, a microphone, a sound system, one or more cameras, and a communication device.

2. The chair of claim 1, wherein the shock absorber is a spring coil or gas lifted.

3. The chair of claim 1, wherein the chair further comprises a wheel portion to enable mobility.

4. The chair of claim 1, wherein a decoration is assembled on the chair.

5. The chair of claim 4, wherein the decoration is selected from a pair of angel wings and ears.

6. The chair of claim 1, wherein at least a camera faces the object to capture the image.

7. The chair of claim 1, wherein the accessory retention arms retain a left table and/or a right table.

8. The chair of claim 5, wherein the left table and right table are connected through their edges fitting to each other.

9. The chair of claim 5, wherein the left table and right table are connected by a fastener.

10. An assembly for chair and chroma key photography backdrop, the assembly comprising:
a chair defined by a sitting portion and a backrest portion, the chair being sized and dimensioned to provide support for an object;
a shock absorber disposed adjacently to the sitting portion, or the backrest portion, or both, the shock absorber being operable to absorb and damp shock impulses from the object being supported on the sitting portion and the backrest portion;
at least one accessory retention arms being fixed under the bottom of the sitting portion of the chair, the accessory retention arms comprising sidewalls that form a cavity, the cavity being sized and dimensioned to retain at least one of the following: a portable desk, a mobile phone, a monitor, a fan, a light source, a microphone, a sound system, one or more cameras, and a communication device; and
a chroma key panel deployable from the backrest portion of the chair, the chroma key panel being defined by a solid color for capturing video images with the one or more cameras;
whereby the cameras layer the image of the object in the chair and a video image together or separately based on the chroma range,
whereby the captured image of the object is separated from the image of the chroma key panel,
whereby a virtual image or video replaces the solid color background of the chroma key panel, such that the object appears to be in front of the virtual image or video.

11. The chair of claim 10, wherein an aroma diffuser being retained in the cavity of the retention arms, the aroma diffusor being operable to diffuse at least one aroma.

12. The chair of claim 10, wherein a smoke diffuser being retained in the cavity of the retention arms, the smoke diffusor being operable to help diffuse smoke.

13. The chair of claim 10, wherein a water spray being retained in the cavity of the retention arms, the water spray being operable to spray a mist.

14. The chair of claim 10, wherein a vibration stimulation motor being integrated into the chair or retained in the cavity of the retention arms, the vibration stimulation motor being operable to vibrate the sitting portion and the backrest portion.

15. The assembly of claim 10, wherein the shock absorber is a spring coil or gas lifted.

16. The assembly of claim 10, wherein the chair further comprises a wheel portion to enable mobility.

17. The assembly of claim 10, wherein the solid color of the chroma key panel is green or blue.

18. The assembly of claim 10, wherein the chroma key panel slidably deploys and retracts into a housing.

19. The assembly of claim 10, wherein four cameras angle to the object from a front view, a rear view, a left-side view, and a right-side view.

20. The assembly of claim 19, wherein the capture videos by the four cameras are combined by chroma key photography software to create a three-dimensional playback or broadcast.
